(19) United States
(12) Patent Application Publication
(10) Pub. No.: US 2019/0159640 A1
(43) Pub. Date: May 30, 2019

(54) BLOWER AND CLEANER

(71) Applicant: Nidec Corporation, Kyoto (JP)

(72) Inventor: Ryosuke HAYAMITSU, Kyoto (JP)

(21) Appl. No.: 16/185,031

(22) Filed: Nov. 9, 2018

Related U.S. Application Data
(60) Provisional application No. 62/590,409, filed on Nov. 24, 2017.

(30) Foreign Application Priority Data
Apr. 12, 2018 (JP) 2018-076724

(51) Int. Cl. A47L 5/22; H02K 5/22; H02K 9/06; F04D 25/06

(52) U.S. Cl. CPC A47L 5/22; F04D 25/06; H02K 9/06; H02K 5/225

(57) ABSTRACT

A blower includes a motor including a shaft that is disposed along a vertically extending central axis, an impeller fixed to the shaft and rotating around the central axis, a motor housing at least a portion of which is disposed on an outside of the motor in a radial direction, a blower case at least a portion of which is disposed on the outside of the motor in the radial direction from an outer surface of the motor housing in the radial direction, and a circuit board below the motor housing and circuit elements disposed therein. A lower end portion of the motor housing includes a housing contraction portion, in which a length of the motor housing in the radial direction decreases as it extends downwardly.

### CROSS REFERENCE TO RELATED APPLICATIONS

This application claims the benefit of priority to United States Patent Application No. 62/590,409 filed on Nov. 24, 2017 and Japanese Patent Application No. 2018-076724 filed on Apr. 12, 2018. The entire contents of these applications are hereby incorporated herein by reference.

### BACKGROUND OF THE INVENTION

### 1. Field of the Invention

The present invention relates to a blower and a cleaner.

### 2. Description of the Related Art

An electric blower includes a motor portion including a stator, a rotor, and a bracket for journaling the rotor, and a fan portion including an impeller rotating on an output shaft of the rotor and a casing covering the impeller, and where a circuit portion for controlling electric power of the motor portion is disposed in the motor portion. In the electric blower, it is possible to efficiency cool a heat generating component of the circuit portion.

More specifically, in the motor portion, a casing is formed by a load side bracket and a counter load side bracket made of metal which is a conductive material. The circuit portion is configured of a first board and a second board. The first board and the second board are disposed so as to be covered by the load side bracket and the counter load side bracket which are the metal casing of the motor portion. The fan portion includes the impeller attached to an upper end portion of a rotation shaft of the rotor, an air guide that is disposed at an outer peripheral portion of the impeller and forms a ventilation path for leading an airflow flowing out from the impeller to an inside of the motor portion, and a casing that is attached to the load side bracket so as to cover the impeller and the air guide.

When the electric blower rotates, the impeller rotates to generate a suction force, air flows from a suction port of the casing into the impeller, and is discharged from the outer periphery of the impeller. The airflow discharged from the outer periphery of the impeller reaches an upper surface of the load side bracket of the motor portion, passes through an opening portion of the load side bracket, and is led to the first board and the second board of the circuit portion. Since a plurality of through-holes penetrating through front and back surfaces of the first board and the second board are provided, the airflow discharged from the outer periphery of the impeller reaches the upper surface of the load side bracket and flows into the motor portion via the through-holes therefrom.

In the electric blower, since a circuit board is disposed between the impeller and the stator in an axial direction, there is a possibility that the circuit board causes airflow resistance and an air blowing efficiency is lowered.

### SUMMARY OF THE INVENTION

A blower according to an exemplary embodiment of the disclosure includes a motor including a shaft that is disposed along a vertically extending central axis; an impeller fixed to the shaft and rotating around the central axis; a motor housing at least a portion of which is disposed on an outside of the motor in a radial direction; a blower case at least a portion of which is disposed on the outside of the motor in the radial direction from an outer surface of the motor housing in the radial direction; and a circuit board which is disposed below the motor housing and in which a plurality of circuit elements are disposed. A lower end portion of the motor housing includes a housing contraction portion in which a length of the motor housing in the radial direction decreases as it extends downwardly.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view of a blower according to an exemplary embodiment of the disclosure.

FIG. 2 is a longitudinal sectional view of a blower according to an exemplary embodiment of the disclosure.

FIG. 3 is a schematic enlarged sectional view illustrating a portion of a lower portion side of the blower.

FIG. 4 is a schematic sectional view illustrating a relationship between a housing contraction portion and a circuit element.

FIG. 5 is a perspective view of a lower housing as viewed obliquely from below.

FIG. 6 is a perspective view of the lower housing as viewed obliquely from above.

FIG. 7 is a plan view of the lower housing.

FIG. 8 is a perspective view illustrating a configuration of a housing enlarged portion and a periphery thereof.

FIG. 9 is a view illustrating a relationship between a housing through-hole and a first circuit element.

FIG. 10 is a view for explaining a relationship between a leg portion and the housing enlarged portion.

FIG. 11 is a perspective view of a cleaner according to an exemplary embodiment of the disclosure.

### DETAILED DESCRIPTION OF THE PREFERRED EMBODIMENTS

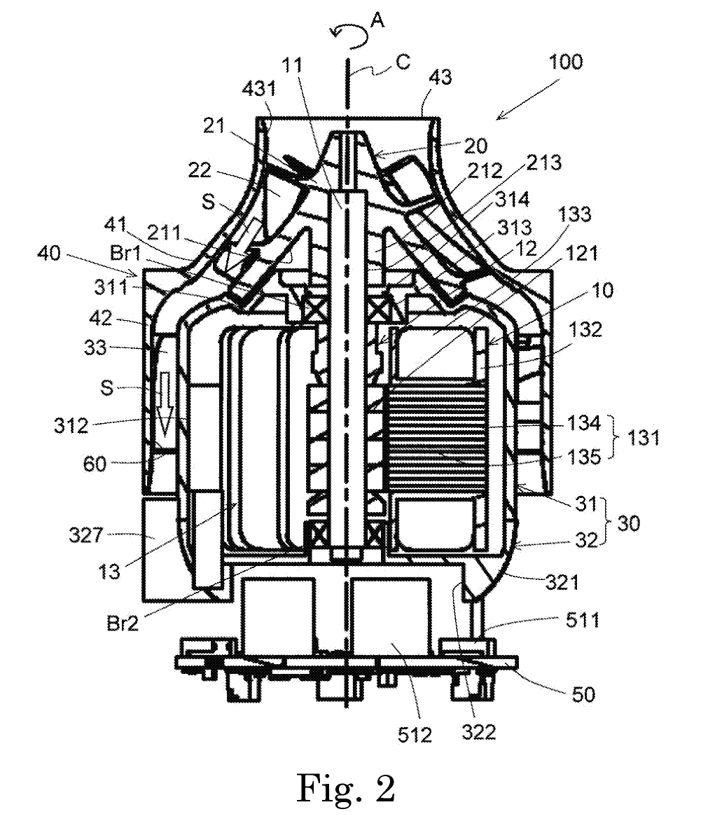

Hereinafter, exemplary embodiments of the disclosure will be described in detail with reference to the drawings. In this specification, in the description of a blower 100, a direction parallel to a central axis C of the blower 100 illustrated in FIG. 2 is referred to as an “axial direction”, a direction orthogonal to the central axis C of the blower A is referred to as a “radial direction”, and a direction along a circular arc with the central axis C as a center is referred to as a “circumferential direction”. In addition, in this specification, in the blower A, a shape and a positional relationship of each portion will be described with the axial direction as a vertical direction, and an impeller 20 side with respect to a motor 10 illustrated in FIG. 2 as an upper side. The vertical direction is simply used for explanation and does not limit an actual positional relationship and direction. In addition, an “upstream side” and a “downstream side” respectively indicate upstream and downstream in a flowing direction of an airflow S generating when the impeller 20 is rotated.

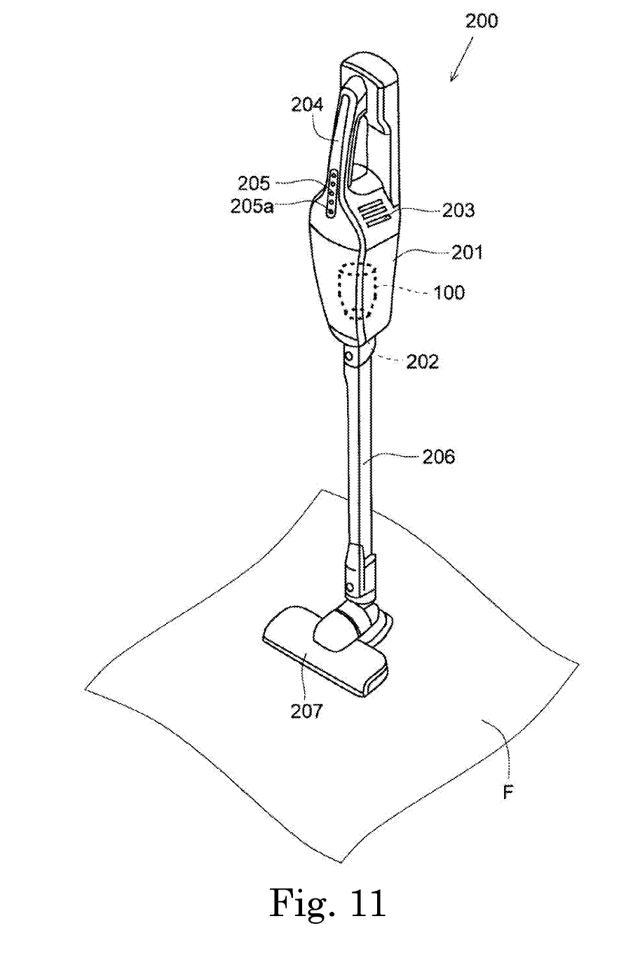

In this specification, when describing a cleaner 200, the shape and the positional relationship of each portion will be described with a direction approaching a floor surface F (surface to be cleaned) of FIG. 11 as “downward” and a direction away from the floor surface F as “upward”. These directions are merely used for explanation and do not limit the actual positional relationship and the directions.

In addition, in this specification, with respect to a plurality of elements having widths in the circumferential direction, an interval between elements in the circumferential direction is defined as an interval between intermediate positions of respective elements in the circumferential direction unless otherwise specified. However, this is a definition used for convenience of explanation and the interval between the elements in the circumferential direction may be defined by another criterion.

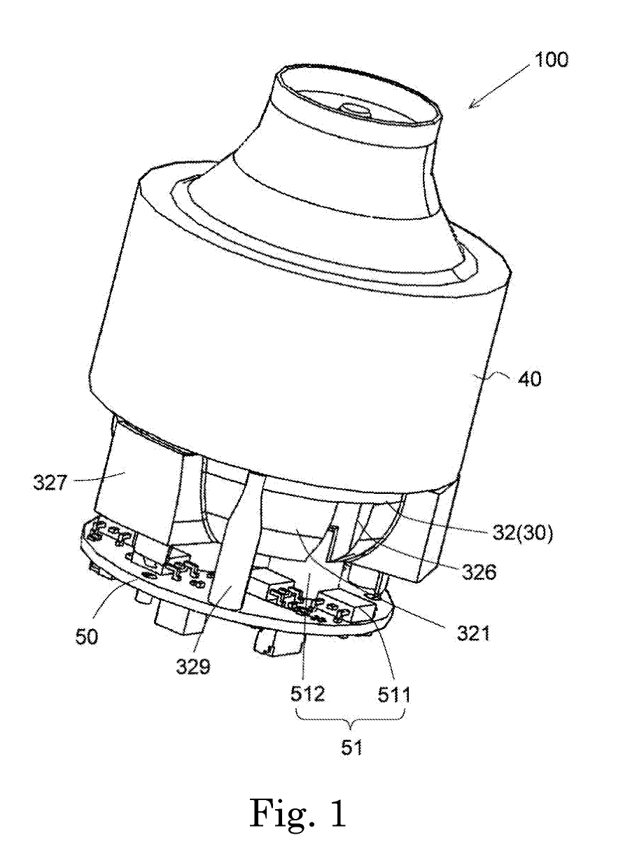

FIG. 1 is a perspective view of the blower 100 according to an exemplary embodiment of the disclosure. FIG. 2 is a longitudinal sectional view of the blower 100 according to the exemplary embodiment of the disclosure. As illustrated in FIGS. 1 and 2, the blower 100 includes the motor 10, the impeller 20, a motor housing 30, a blower case 40, and a circuit board 50.

In the blower 100, the impeller 20 and a part of the motor housing 30 are accommodated in the blower case 40. Specifically, the blower case 40 accommodates an upper side of the motor housing 30. As illustrated in FIG. 2, a flow path 60 is formed between the blower case 40 and an upper housing 31, which is described later, of the motor housing 30 in the radial direction.

The motor 10 is accommodated in the motor housing 30. The motor 10 includes a shaft 11 disposed along the central axis C extending vertically. The impeller 20 is fixed to the shaft 11 and rotates around the central axis C. The motor 10 is disposed below the impeller 20 to rotate the impeller 20. The impeller 20 is rotated around the central axis C by the rotation of the motor 10 and an air flow is generated.

The motor 10 is a so-called inner rotor type motor. However, the disclosure may be applied to a so-called outer rotor type motor. The motor 10 includes a rotor 12 and a stator 13 in addition to the shaft 11. Moreover, in the embodiment, the shaft 11 has a cylindrical shape. As illustrated in FIG. 2, the shaft 11 penetrates through an upper shaft hole 314 provided in an upper housing top plate 311, which is described later, of the upper housing 31. The impeller 20 is fixed to an end portion of the shaft 11 protruding upward from the upper housing top plate 311. The shaft 11 is rotatably supported by an upper bearing Br1 and a lower bearing Br2 disposed to be spaced apart in the

In the embodiment, the upper bearing Br1 and the lower bearing Br2 are ball bearings. The shaft 11 is fixed to inner races of the upper bearing Br1 and the lower bearing Br2. As a fixing method, adhesion or press fitting may be adopted. An outer ring of the upper bearing Br1 is fixed to the upper housing 31 and an outer ring of the lower bearing Br2 is fixed to a lower housing 32. Moreover, the bearing rotatably supplying the shaft 11 is not limited to ball bearing, but may be, for example, a sleeve bearing or the like. Also, the number of the bearings is not limited to two, but may be one or three or more.

The rotor 12 is fixed to the shaft 11. The rotor 12 rotates together with the shaft 11. In the embodiment, the rotor 12 has a cylindrical magnet 121. The magnet 121 is disposed on an outside of the shaft 11 in the radial direction and fixed to the shaft 11. On an outer surface of the magnet 121 in the radial direction, an N pole and an S pole are alternately arranged in the circumferential direction. Moreover, the magnet 121 may be formed of one magnet, or may be formed of a plurality of magnet pieces.

The stator 13 is disposed on the outside of the rotor 12 in the radial direction. The stator 13 includes a stator core 131, an insulator 132, and a coil 133. The stator core 131 is a laminated body in which electromagnetic steel plates are laminated in the axial direction. However, the stator core 131 may be, for example, a single member formed of powder calcination casting or the like.

The stator core 131 has an annular shape around the central axis C. The annular stator core 131 has an annular core back 134 and a plurality of teeth 135. The core back 134 has an annular shape around the central axis C. The teeth 135 protrude to the inside in the radial direction from an inner surface of the core back 134 in the radial direction. The plurality of the teeth 135 are disposed at equal intervals in the circumferential direction.

The insulator 132 is an insulating member that covers at least a part of the stator core 131. The coil 133 is configured by winding a conductive wire around each of the teeth 135 via the insulator 132. That is, the stator 13 has a plurality of the coils 133. When electric power is supplied from an electric power source to each coil 133, magnetic flux is generated in each of the teeth 135. A torque in the circumferential direction is generated by operations of the magnetic flux generated in each of the teeth 135 and a magnetic field generated by the magnet 121. As a result, the rotor 12 rotates about the central axis C together with the shaft 11.

At least a part of the motor housing 30 is disposed on the outside of the motor 10 in the radial direction. In the embodiment, a part thereof is disposed on the outside of the motor 10 in the radial direction. The motor housing 30 is made of, for example, metal or resin. The motor housing 30 includes the upper housing 31 and the lower housing 32. The lower housing 32 is disposed below the upper housing 31. The upper housing 31 and the lower housing 32 can be connected to each other, for example, by a screw, a snap fit, an adhesive, or the like. The motor housing 30 is separated into two members, so that mass productivity of the motor housing 30 having a complicated shape can be improved. Details of the configuration of the motor housing 30 will be described later.

The impeller 20 is a so-called mixed flow impeller formed of a resin such as engineering plastic. The engineering plastic is a resin of which mechanical properties such as strength and heat resistance are superior to other resins. Moreover, the impeller 20 may be formed of another material such as metal. The impeller 20 includes a hub portion 21 and a plurality of blades 22. A diameter of the hub portion 21 increases as it extends downwardly. In other words, the diameter of the hub portion 21 increases as it extends downwardly. The hub portion 21 includes a lower surface recess portion 211 and a boss portion 212.

The lower surface recess portion 211 is recessed upward from a lower surface of the hub portion 21. The lower surface recess portion 211 has an annular shape about the central axis C. The hub portion 21 can be recessed in weight by providing the lower surface recess portion 211. The power consumption can be reduced and the impeller 20 can be rotated at a high speed by reducing the weight.

The boss portion 212 is provided on the inside of the lower surface recess portion 211 in the radial direction. The boss portion 212 has a cylindrical shape about the central axis C. The boss portion 212 is provided with a hole portion 213 penetrating in the axial direction about the central axis C. The shaft 11 is press-fitted into the hole portion 213. Therefore, the impeller 20 and the shaft 11 are connected and the impeller 20 rotates about the central axis C. In the embodiment, the impeller 20 rotates in a direction of an arrow A of FIG. 2. The impeller 20 rotates in the counterclockwise direction as viewed in plan view of the blower 100.

The blades 22 are provided on an outer surface of the hub portion 21. The plurality of the blades 22 are disposed at intervals in the circumferential direction. In the embodiment, the blades 22 are juxtaposed at predetermined intervals in the circumferential direction on the outer surface of the hub portion 21, and are formed integrally with the hub portion 21. An upper portion of the blade 22 is disposed forward in the rotation direction with respect to a lower portion thereof. That is, the blade 22 is inclined with respect to the central axis C.

At least a part of the blower case 40 is disposed on the outside in the radial direction from the outer surface of the motor housing 30 in the radial direction. In the embodiment, a part thereof is disposed on the outside of the motor housing 30 in the radial direction. Moreover, the blower case 40 may be a separate member from the motor housing 30, or may be a single member with at least a part of the motor housing 30.

Specifically, the blower case 40 includes an upper case 41 and a lower case 42. That is, the blower case 40 is formed of two members. However, the blower case 40 may be formed of a single member.

The upper case 41 has a cylindrical shape that is tapered upward in the axial direction with the central axis C as a center. The upper case 41 is disposed on the outside of the impeller 20 in the radial direction. The upper case 41 includes an intake port 43 at an upper portion. The intake port 43 includes a bell mouth 431 which bends inward from an upper end and extends downward. Therefore, a diameter of the intake port 43 smoothly decreases from the upper side to the lower side. The upper case 41 includes the bell mouth 431, so that it is possible to smoothly draw the air. Therefore, an amount of the air drawing from the intake port 43 during the rotation of the impeller 20 increases.

The lower case 42 has a cylindrical shape extending in the axial direction with the central axis C as a center. The lower case 42 is disposed below the upper case 41 and is fixed to the upper case 41. The lower case 42 is disposed on the outside of the upper housing 31 in the radial direction. A gap is provided between the lower case 42 and the upper housing 31 in the radial direction. A plurality of stationary blades 33 are juxtaposed in the gap between the lower case 42 and the upper housing 31 in the radial direction at equal intervals in the circumferential direction. In the embodiment, the lower case 42, the upper housing 31, and the plurality of the stationary blades 33 are formed of a single member.

The circuit board 50 is disposed below the motor housing 30. For example, circuits for driving the motor 10 such as a power supply circuit and a control circuit are provided in the circuit board 50. A plurality of circuit elements 51 are disposed in the circuit board 50. The plurality of the circuit elements 51 are mounted on the circuit board 50. The circuit board 50 has printed wiring formed of, for example, a metal film and the plurality of the circuit elements 51 configure the power supply circuit and the control circuit together with the printing wiring. In the embodiment, the plurality of the circuit elements 51 include a field effect transistor (FET) and an electrolytic capacitor.

Moreover, in the embodiment, the FET is adopted as a transistor, but the disclosure is not limited thereto and, for example, a bipolar transistor, an IGBT, a MOSFET, or the like may be adopted as the transistor. In addition, in the embodiment, the electrolytic capacitor is adopted as a capacitor, but the disclosure is not limited thereto and, for example, a ceramic capacitor, a film capacitor, or the like may be adopted as the capacitor.

The motor 10 is driven, so that the shaft 11 rotates and the impeller 20 fixed to the shaft 11 rotates. As indicated by thick arrows in FIG. 2, the impeller 20 rotates to generate the airflow S. The airflow S generated by the rotation of the impeller 20 flows into the flow path 60 formed between the upper housing 31 and the lower case 42 in the radial direction. The airflow S flowing into the flow path 60 is rectified by the stationary blades 33 which are described later. The airflow S becomes a flow that is axially symmetric about the central axis C by the stationary blades 33. The airflow S is drawn out downward from a lower end of the blower case 40. A part of the airflow S which is drawn out downward flows to the outside of the blower 100. In addition, the other part of the airflow S which is drawn out downward flows toward the circuit board 50.

As described above, in the embodiment, the motor housing 30 is configured of the upper housing 31 and the lower housing 32. That is, the motor housing 30 is configured of two members. However, the motor housing 30 may be configured of a single member.

As illustrated in FIG. 2, the upper housing 31 includes the upper housing top plate 311 and an upper housing cylindrical portion 312. The upper housing top plate 311 expands in a direction orthogonal to the central axis C. The upper housing top plate 311 has a circular shape with the central axis C as a center as viewed in plan view from the axial direction. The upper housing cylindrical portion 312 extends downward in the axial direction from an outer edge of the upper housing top plate 311 in the radial direction. The upper housing cylindrical portion 312 has a cylindrical shape with the central axis C as a center. The upper housing top plate 311 and the upper housing cylindrical portion 312 are configured of a single member. The upper housing cylindrical portion 312 is disposed on the outside of the stator 13 in the radial direction.

A lower surface of the upper housing top plate 311 faces the rotor 12 and the stator 13 in the axial direction. The upper housing top plate 311 includes an upper bearing holding portion 313 and the upper shaft hole 314. The upper bearing holding portion 313 has a recess portion which is recessed upward at a center portion of the lower surface of the upper housing top plate 311. In addition, the upper shaft hole 314 is a through-hole which penetrates in the axial direction with the central axis C as a center. Centers of the upper bearing holding portion 313 and the upper shaft hole 314 coincide. An outer ring of the upper bearing Br1 is fixed to the upper bearing holding portion 313. The shaft 11 passes through the upper shaft hole 314.

The stator 13 is press-fitted into an inner peripheral surface of the upper housing cylindrical portion 312. The plurality of the stationary blades 33 are provided on an outer peripheral surface of the upper housing cylindrical portion 312. The plurality of the stationary blades 33 are disposed on the outside of an outer surface of the upper housing cylindrical portion 312 in the radial direction and on an inside of an inner surface of the lower case 42 in the radial direction.

In the embodiment, the upper housing cylindrical portion 312 and the stationary blade 33 are configured of a single member. However, the upper housing cylindrical portion 312 and the stationary blades 33 may be configured of separate members. In this case, the stationary blades 33 may be fixed to the upper housing cylindrical portion 312 by, for example, adhesive or the like. In addition, in the embodiment, the stationary blade 33 is also a single member with the lower case 42. That is, the upper housing 31, the stationary blade 33, and the lower case 42 are configured of a single member.

The plurality of the stationary blades 33 are disposed on the outer surface of the upper housing 31 in the radial direction at equal intervals in the circumferential direction. Each of the stationary blades 33 is formed in a plate shape and inclines in a direction opposite to the rotation direction of the impeller 20 as it goes upwardly. The stationary blade 33 is convexly curved on the impeller 20 side. The outer surfaces of the plurality of the stationary blades 33 in the radial direction are in contact with the inner surface of the lower case 42 in the radial direction. The plurality of the stationary blades 33 are juxtaposed in the circumferential direction and guide the airflow S downward when the blower 100 is driven. The stationary blades 33 are disposed on the inside of the flow path 60 and rectify the airflow S flowing through the flow path 60.

In addition, the stationary blades 33 are disposed on the outer surface of the upper housing 31 in the radial direction at equal intervals in the circumferential direction. Therefore, the airflow S on the outer surface of the upper housing 31 in the radial direction can be made close to axial symmetry and cooling characteristics of the upper housing 31 can be brought to close to uniformity in the circumferential direction.

In the motor 10, heat is generated from the coil 133 and the surrounding thereof with the rotation. The heat is transmitted to the upper housing 31. The stationary blade 33 protruding to the outside in the radial direction are provided on the outer peripheral surface of the upper housing 31 and the stationary blades 33 are disposed on the inside of the flow path 60. Therefore, the stationary blades 33 also serve as radiation fins for rectifying the airflow S and for releasing the heat of the upper housing 31 to the outside. Therefore, it is possible to efficiently cool the upper housing 31 which is heated by the heat of the stator 13.

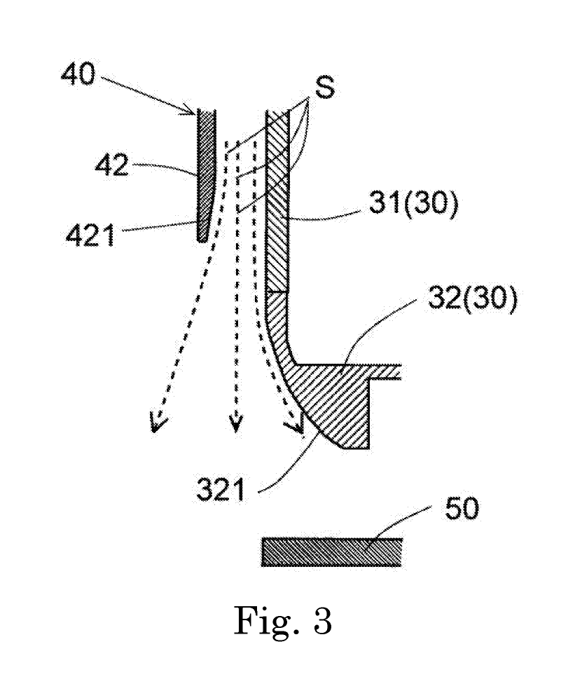

FIG. 3 is a schematic enlarged sectional view illustrating a part of a lower portion side of the blower 100. As illustrated in FIGS. 1 to 3, the motor housing 30 has a housing contraction portion 321, in which a length of the motor housing 30 in the radial direction is decreased as it extends downwardly, at a lower end portion. In the embodiment, the lower housing 32 has the housing contraction portion 321. The housing contraction portion 321 has a specific shape provided on the outer surface of the lower housing 32 in the radial direction.

As illustrated in FIG. 3, a part of the airflow S drawn out from a lower end of the blower case 40 through the flow path 60 in accordance with the rotation of the impeller 20 can be guided by the housing contraction portion 321 downward and inward in the radial direction. The airflow S induced by the housing contraction portion 321 is directed toward the circuit board 50 disposed below the motor housing 30 and can cool a heat generating component on the circuit board 50. In other words, the airflow S, which is guided by the housing contraction portion 321, is smoothly guided toward the circuit board 50 on the inside of the blower case 40 and is directed toward the outside of the blower case 40. Therefore, in the blower 100, it is possible to suppress reduction of the blowing efficiency and to cool the circuit board 50 at the same time.

Moreover, the other part of the airflow S which is drawn out from the lower end of the blower case 40 flows to the outside of the blower 100 without abutting against the circuit board 50. A blower case enlarged portion 421, which enlarges an inner diameter as it extends downwardly, is disposed at the lower end portion of the inner surface of the blower case 40 in the radial direction. In the embodiment, the blower case enlarged portion 421 is provided in the lower case 42. The blower case enlarged portion 421 is provided, so that it is possible to efficiently generate the airflow S not directed to the circuit board 50. It is possible to suppress that an air pressure below the impeller 20 becomes too high by generating the airflow S not directed to the circuit board 50. That is, it is possible to suppress that a load applied to the impeller 20 becomes too high and to suppress reduction of the blowing efficiency.

In the embodiment, the housing contraction portion 321 is a curved portion that is projected downward and outward in the radial direction. That is, the housing contraction portion 321 is a convex curved surface. It is possible to smoothly guide the airflow S from the impeller 20 toward the circuit board 50 by such a configuration. That is, it is possible to efficiently guide the airflow S from the impeller 20 toward the circuit board and to improve the cooling efficiency.

Moreover, the housing contraction portion 321 may have, for example, another shape such as an inclined surface which is directed inward in the radial direction as it extends downwardly or a curved surface which is recessed upward and inward in the radial direction.

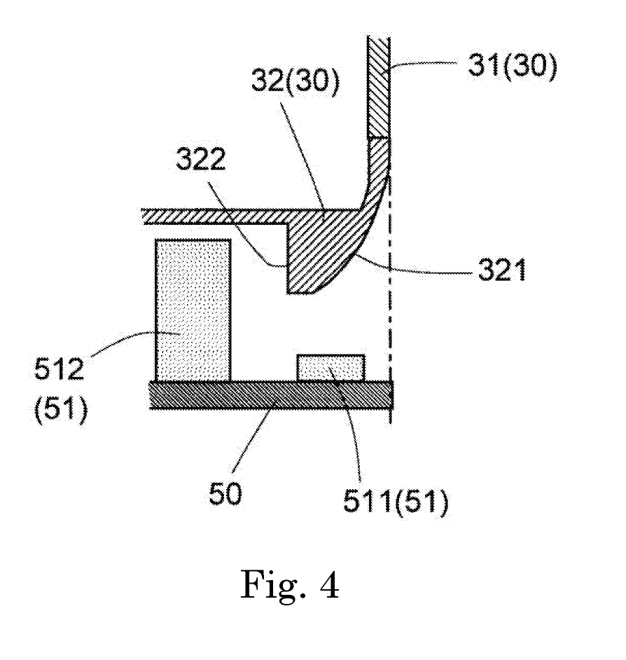

FIG. 4 is a schematic sectional view illustrating a relationship between the housing contraction portion 321 and the circuit element 51. As illustrated in FIG. 4, a first circuit element 511 having a highest temperature among the plurality of the circuit elements 51 is positioned on the inside in the radial direction from an outer end of the housing contraction portion 321 in the radial direction. In the embodiment, the first circuit element 511 is the FET. The first circuit element 511 may be other than the FET. Moreover, “highest temperature is reached” is an expression when compared to a temperature of a case where the airflow S is not applied. According to the configuration of the embodiment, it is easy to apply the airflow S to the first circuit element 511 and it is possible to efficiently suppress the high temperature of the first circuit element 511 and the circuit board 50.

Moreover, it is preferable that an entirety of the first circuit element 511 is positioned on the inside of the housing contraction portion 321 in the radial direction. However, a part of the first circuit element 511 may be positioned on the inside of the housing contraction portion 321 in the radial direction. In addition, in a case where a plurality of the first circuit elements 511 are provided, it is preferable that all the first circuit elements 511 are positioned on the inside in the radial direction from the outer end of the housing contraction portion 321 in the radial direction. However, the first circuit element 511 positioned on the outside in the radial direction from the outer end of the housing contraction portion 321 in the radial direction may be included in the plurality of the first circuit elements 511.

It is preferable that a region in the circumferential direction of at least a part of the housing contraction portion 321 overlaps with the first circuit element 511 in the radial direction. Therefore, the airflow S guided by the housing contraction portion 321 can be directly applied to the first circuit element 511 having the highest temperature and to efficiently perform cooling of the first circuit element 511 and the circuit board 50.

Moreover, in a case where the plurality of the first circuit elements 511 are provided, it is preferable that all the first circuit element 511 overlaps with at least a part of the region in the circumferential direction of the housing contraction portion 321 in the radial direction. However, the first circuit element 511, which does not overlap with the region in the circumferential direction of the housing contraction portion 321 in the radial direction, may be included in the plurality of the first circuit elements 511.

As illustrated in FIG. 4, the motor housing 30 includes a housing recess portion 322 which is recessed inward in the radial direction and upward in the housing contraction portion 321. In the embodiment, the lower housing 32 includes the housing recess portion 322. The housing recess portion 322 has a circular shape with the central axis C as a center.

As illustrated in FIG. 4, at least an upper portion of a second circuit element 512 having a longest length in the axial direction among the plurality of the circuit elements 51 is accommodated in the housing recess portion 322. In the embodiment, the second circuit element 512 is an electrolytic capacitor. The second circuit element 512 may be other than the electrolytic capacitor. An upper portion of the second circuit element 512 is accommodated in the housing recess portion 322 and a lower portion is positioned on an outside of the housing recess portion 322.

According to the configuration of the embodiment, since the upper portion of the second circuit element 512 having the longest length in the axial direction is on the inside of the housing recess portion 322, it is possible to reduce a distance between the motor housing 30 and the circuit board 50 in the axial direction. That is, a size of the blower 100 in the axial direction can be recessed. In addition, in order to reduce the size of the blower 100 in the axial direction, it is not necessary to dispose the second circuit element 512 on the outside in the radial direction from the outer end of the motor housing 30 in the radial direction, and it is also possible to reduce the size of the blower 100 in the radial direction.

Moreover, in a case where a plurality of second circuit elements 512 are provided, it is preferable that at least upper portions of all the second circuit elements 512 are accommodated in the housing recess portion 322. However, the second circuit element 512 of which at least the upper portion is not accommodated in the housing recess portion 322 may be included in the plurality of the second circuit elements 512.

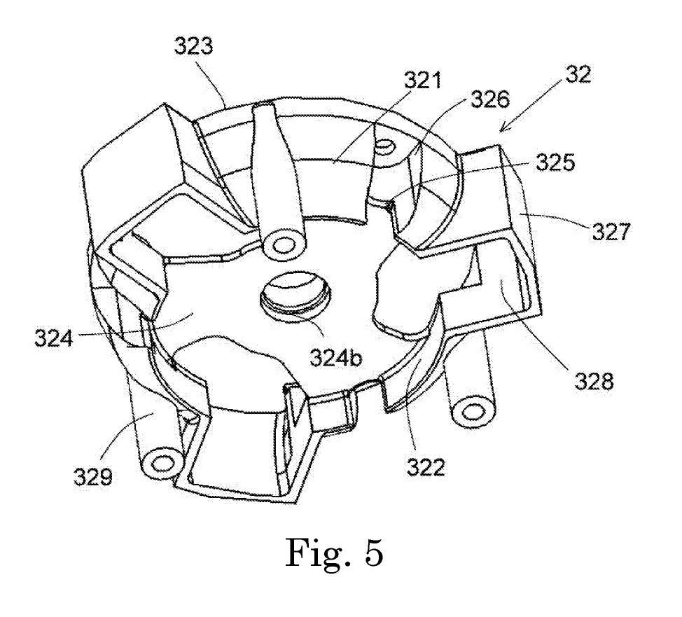

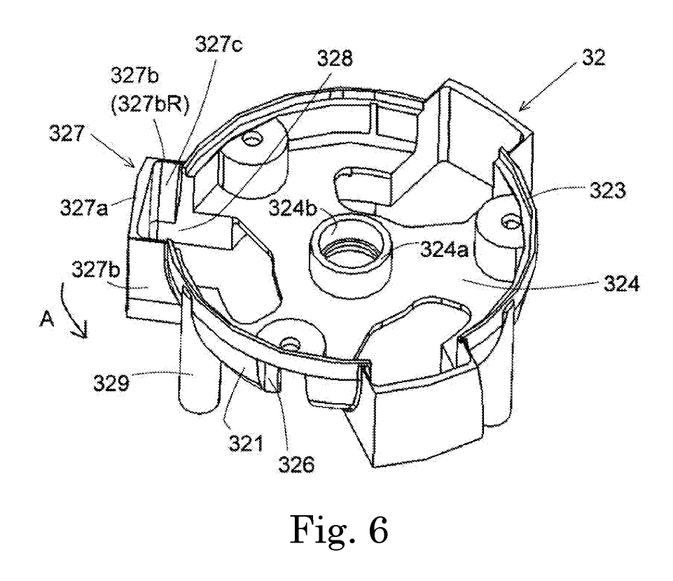

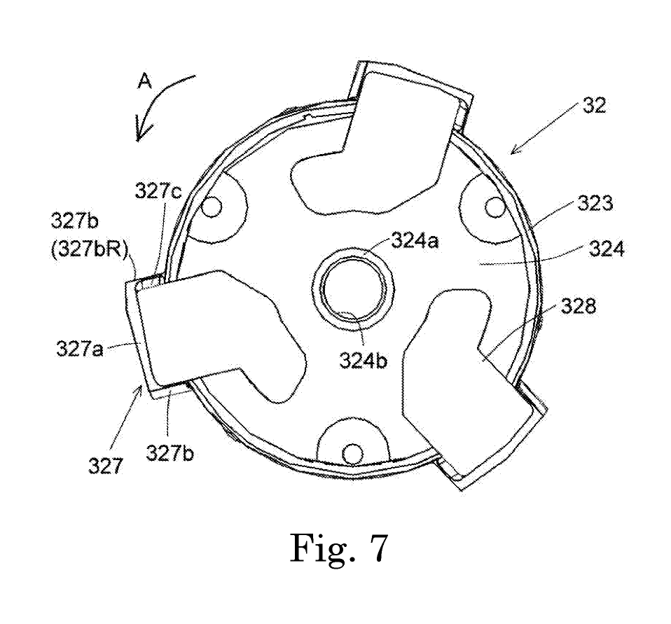

FIG. 5 is a perspective view of the lower housing 32 as viewed obliquely from below. FIG. 6 is a perspective view of the lower housing 32 as viewed obliquely from above. FIG. 7 is a plan view of the lower housing 32.

As illustrated in FIGS. 5 to 7, the lower housing 32 includes a lower housing cylindrical portion 323 and a lower housing lid portion 324. The lower housing cylindrical portion 323 has a cylindrical shape extending in the axial direction with the central axis C as a center. Since the lower housing cylindrical portion 323 has the housing contraction portion 321 on the outer surface in the radial direction, a length in the radial direction becomes shorter as it extends downwardly. The lower housing lid portion 324 has a plate shape orthogonal to the central axis C. The lower housing lid portion 324 is disposed in the lower housing cylindrical portion 323. The lower housing cylindrical portion 323 and the lower housing lid portion 324 are configured of a single member. The lower housing lid portion 324 configures an upper wall of the housing recess portion 322 which is recessed upward.

The lower housing lid portion 324 includes a lower bearing holding portion 324a and a lower shaft hole 324b. The lower bearing holding portion 324a includes a recess portion which protrudes upward from a center portion of the lower housing lid portion 324 and of which a center portion is recessed downward. An outer ring of the lower bearing Br2 is fixed to the recess portion of the lower bearing holding portion 324a. The lower shaft hole 324b is a through-hole penetrating through the center portion of the lower housing lid portion 324 in the axial direction. The shaft 11 passes through the lower shaft hole 324b. Centers of the lower bearing holding portion 324a and the lower shaft hole 324b coincide.

The lower housing 32 is attached to a lower side of the upper housing 31. That is, an upper end portion of the lower housing cylindrical portion 323 is in contact with a lower end portion of the upper housing cylindrical portion 312. Therefore, at least a part of the lower surface of the upper housing 31 covers the lower housing 32. In the embodiment, the lower housing 32 is fixed to the upper housing 31 using a screw. Moreover, the upper housing 31 and the lower housing 32 may be made of the same material or different materials.

As illustrated in FIG. 5, the lower housing 32 includes a housing opening portion 325. In other words, the motor housing 30 includes the housing opening portion 325. The housing opening portion 325 penetrates through between the housing contraction portion 321 and the housing recess portion 322 in the radial direction. In the embodiment, the housing opening portion 325 is a notch which is recessed upward from a bottom surface of the lower housing 32. The notch has a rectangular shape as viewed in plan view from the radial direction. However, the notch is not limited to the rectangular shape, but may be another shape such as a semicircle shape. In addition, the housing opening portion 325 may be a through-hole instead of the notch. The airflow S can escape from the housing opening portion 325 to the outside and an amount of the airflow staying in the housing recess portion 322 can be reduced. Therefore, a load applied to the impeller 20 can be reduced. In addition, since it is possible to suppress that the airflow is stayed in the housing recess portion 322, for example, it is possible to efficiently cool the circuit element 51 such as an electrolytic capacitor.

In the embodiment, a plurality of housing opening portions 325 are provided in the circumferential direction. The plurality of the housing opening portions 325 are disposed at equal intervals in the circumferential direction. Specifically, the lower housing 32 includes three housing opening portions 325. The three housing opening portions 325 are provided at intervals of 120° in the circumferential direction. Therefore, the airflow S can escape uniformly to the outside via the housing opening portion 325 in the circumferential direction.

As illustrated in FIGS. 5 and 6, the lower housing 32 includes a housing groove 326 which is recessed on the inside in the radial direction in the housing contraction portion 321. In other words, the motor housing 30 includes the housing groove 326 which is recessed on the inside in the radial direction in the housing contraction portion 321. The housing groove 326 is recessed on the inside in the radial direction from the curved surface configuring the housing contraction portion 321. In the embodiment, the housing groove 326 extends from an upper end to a lower end of the housing contraction portion 321.

The housing groove 326 is provided at a position overlapping with the housing opening portion 325 in the radial direction. Specifically, the housing groove 326 is larger than the housing opening portion 325 as viewed in plan view from the radial direction and the housing opening portion 325 is provided in a region of the housing groove 326. In the embodiment, the number of the housing grooves 326 is three that is the same as that of the housing opening portions 325. The three the housing grooves 326 are disposed at equal intervals in the circumferential direction.

At the position where the housing groove 326 is provided, no airflow S along the housing contraction portion 321 is generated and most of the airflow S hardly has a component directed to the inside in the radial direction. Therefore, at the position where the housing groove 326 is provided, the airflow S is hardly directed to the circuit board 50. That is, the housing groove 326 is provided, so that it is possible to suppress that an amount of the airflow flowing toward the circuit board 50 excessively increases. That is, it is possible to suppress an excessive increase in the amount of the airflow rising by abutting against the circuit board 50 and to suppress that the air pressure in a space between the upper surface of the circuit board 50 and the lower end of the motor housing 30 in the axial direction increases. Therefore, the load applied to the impeller 20 can be reduced.

As illustrated in FIGS. 5 to 7, the lower housing 32 includes a housing enlarged portion 327. In other words, the motor housing 30 includes the housing enlarged portion 327. The housing enlarged portion 327 is disposed between the housing contraction portions 321 in the circumferential direction, which are adjacent to each other in the circumferential direction, and protrudes to the outside in the radial direction. The housing enlarged portion 327 protrudes from the outer surface of the lower housing cylindrical portion 323 in the radial direction to the outside in the radial direction. The housing enlarged portion 327 is a single member together with the lower housing cylindrical portion 323. However, the housing enlarged portion 327 may be a separate member from the lower housing cylindrical portion 323.

As illustrated in FIGS. 6 and 7, the housing enlarged portion 327 includes an enlarged portion outer wall portion 327a and a pair of enlarged portion side wall portions 327b. The enlarged portion outer wall portion 327a is disposed on the outside in the radial direction from the housing contraction portion 321. The pair of the enlarged portion side wall portions 327b connects both end portions of the enlarged portion outer wall portion 327a in the circumferential direction and the housing contraction portion 321. The housing enlarged portion 327 has a substantially U shape as viewed in plan view from the axial direction. The housing enlarged portion 327 extends from an upper end to a lower end of the lower housing cylindrical portion 323 in the axial direction.

At a position where the housing enlarged portion 327 is provided, the length the lower housing 32 in the radial direction is longer than that at a position where the housing enlarged portion 327 is not provided. In the embodiment, a plurality of housing enlarged portions 327 are disposed at equal intervals in the circumferential direction. Specifically, the number of the housing enlarged portions 327 is three. However, the number of the housing enlarged portions 327 may be other than three, or may be one. One housing groove 326 and one housing opening portion 325 are provided between two housing enlarged portions 327 adjacent to each other in the circumferential direction.

A housing through-hole 328 penetrating in the axial direction is provided on the inside in the radial direction from the outer surface of the housing enlarged portion 327 in the radial direction. Specifically, the housing through-hole 328 includes a space which is surrounded by the enlarged portion outer wall portion 327a and the pair of the enlarged portion side wall portions 327b. The housing through-hole 328 also includes a space penetrating through a part of the lower housing lid portion 324 in the axial direction.

In the embodiment, the plurality of the housing enlarged portions 327 are disposed at equal intervals in the circumferential direction at predetermined angles. Therefore, a plurality of housing through-holes 328 are disposed in the circumferential direction. Specifically, three housing through-holes 328 are disposed at equal intervals of 120° in the circumferential direction. At least a part of the housing through-hole 328 overlaps with the flow path 60 formed between the upper housing 31 and the lower case 42 as viewed in plan view from the axial direction. Therefore, a part of the airflow S drawn out downward from the flow path 60 can pass through the housing through-hole 328.

As illustrated in FIGS. 6 and 7, an enlarged portion side wall portion 327bR which is disposed on a back side of the impeller in the rotation direction in the pair of the enlarged portion side wall portions 327b includes a through-hole enlarged portion 327c. An arrow A in FIGS. 6 and 7, indicates the rotation direction of the impeller 20. The through-hole enlarged portion 327c is provided on a surface of the impeller 20 on a front side in the rotation direction. The through-hole enlarged portion 327c is directed to the back side of the impeller 20 in the rotation direction as it goes upwardly. In other words, the upper end of the through-hole enlarged portion 327c is provided, so that the housing through-hole 328 is wider than the lower end. According to the configuration, it is possible to smoothly guide the airflow S having the constant in the rotation direction of the impeller 20 downward along the through-hole enlarged portion 327c.

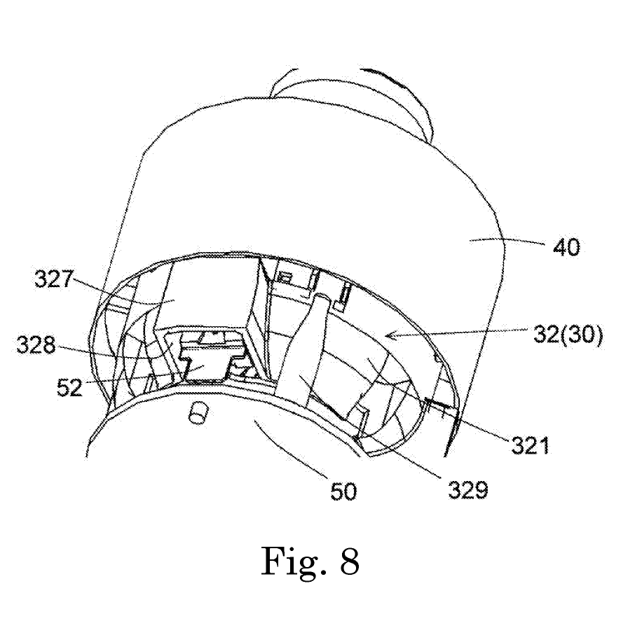

FIG. 8 is a perspective view illustrating a configuration of the housing enlarged portion 327 and a periphery thereof. As illustrated in FIG. 8, a connecting portion 52 is disposed in the housing through-hole 328. The connecting portion 52 electrically connects the motor 10 and the circuit board 50. The connecting portion 52 has conductivity and electrically connects the coil 133 and the circuit board 50. The connecting portion 52 may be, for example, a tab terminal or the like. In the embodiment, the number of the connecting portions 52 is three and one connecting portion 52 is disposed in each of the housing through-holes 328.

According to the embodiment, since the connecting portion 52 can be disposed on the outside of the circuit board 50 in the radial direction, many circuit elements 51 can be disposed on the inside of the housing contraction portion 321 in the radial direction. In addition, it is possible to cool the connecting portion 52 by the airflow S passing through the housing through-hole 328. In addition, in the embodiment, since the plurality of the housing through-holes 328 are provided in the circumferential direction, each of a plurality of the connecting portions 52 can be disposed in the housing through-hole 328 and it is possible to efficiently cool each of the connecting portions 52.

As illustrated in FIG. 7, the housing through-hole 328 extends to the front side of the impeller 20 in the rotation direction as it goes inwardly in the radial direction. In the embodiment, shapes of three housing through-holes 328 are the same. That is, when a certain housing through-hole 328 is rotated by 120° around the central axis C, the housing through-hole 328 overlaps with adjacent another housing through-hole 328. It is possible to efficiently guide the airflow having a forward component of the impeller 20 in the rotation direction.

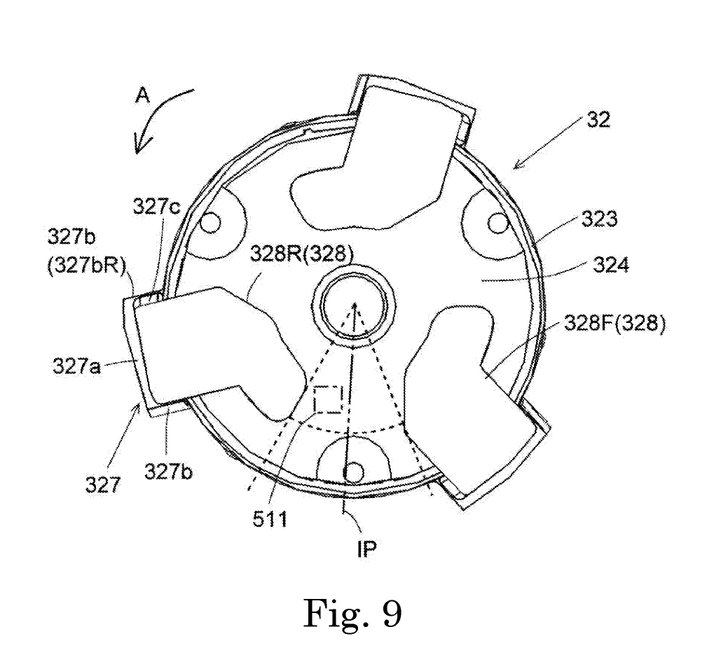

FIG. 9 is a view illustrating a relationship between the housing through-hole 328 and the first circuit element 511. FIG. 9 is a view assuming a state where the lower housing 32 is viewed from above. In FIG. 9, although the first circuit element 511 overlaps with the lower housing 32 in the axial direction and is not inherently visible, in FIG. 9, the first circuit element 511 is indicated by an one-dotted chain line. In FIG. 9, an arrow A indicates the rotation direction of the impeller 20.

As described above, the first circuit element 511 is the circuit element having the highest temperature among the plurality of the circuit elements 51. As illustrated in FIG. 9, it is preferable that at least one of the first circuit elements 511 is positioned on the back side of the impeller 20 in the rotation direction from a circumferential intermediate position IP. The circumferential intermediate position IP is an intermediate position between a front end of the impeller in the rotation direction in a housing through-hole 328R, which is disposed on the back side of the impeller 20 in the rotation direction, and a back end of the impeller 20 in the rotation direction in a housing through-hole 328F, which is disposed on the front side of the impeller 20 in the rotation direction, between the housing through-holes 328 in the circumferential direction, which are adjacent to each other in the circumferential direction.

With such a configuration, the airflow S having the component of the rotation direction of the impeller 20 can directly abut against the first circuit element 511 and it is possible to efficiently cool the first circuit element 511. That is, it is possible to efficiently suppress the high temperature of the first circuit element 511 and the circuit board 50. Moreover, it is preferable that the first circuit element 511 is positioned on the back side of the impeller 20 in the rotation direction from the circumferential intermediate position IP. However, a part of the first circuit element 511 may be positioned on the back side of the impeller 20 in the rotation direction from the circumferential intermediate position IP.

As illustrated in FIGS. 1, 5, 6, and the like, the lower housing 32 includes a plurality of leg portions 329. That is, the motor housing 30 has the plurality of the leg portions 329. The plurality of the leg portions 329 protrude downward and are connected to the circuit board 50. In the embodiment, the leg portion 329 protrudes downward from the lower end of the lower housing cylindrical portion 323. The leg portion 329 has a lidded cylindrical shape extending in the axial direction. Screws pass through the leg portions 329, so that the motor housing 30 and the circuit board 50 are connected. In the embodiment, the number of the leg portions 329 is three. The plurality of the leg portions 329 are disposed at equal intervals in the circumferential direction at predetermined angles. The three leg portions 329 are disposed at equal intervals of 120° in the circumferential direction.

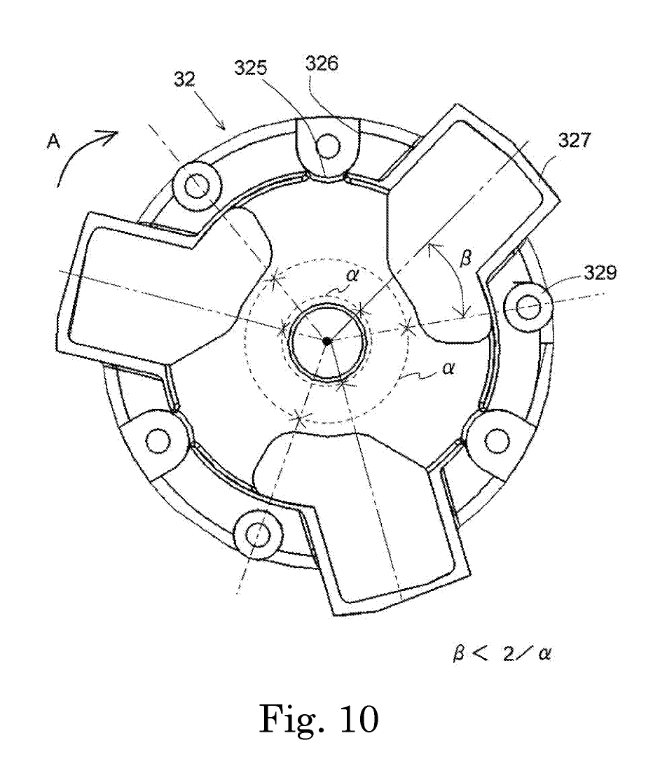

FIG. 10 is a view for explaining a relationship between the leg portion 329 and the housing enlarged portion 327. FIG. 10 is a plan view of the lower housing 32 as viewed from below. In FIG. 10, an arrow A indicates the rotation direction of the impeller 20.

Three housing enlarged portions 327 and three leg portions 329 are disposed at equal intervals in the circumferential direction at predetermined angles α (=120°). However, circumferential positions of the housing enlarged portion 327 and the leg portion 329 are different. In other words, the circumferential positions of the housing enlarged portion 327 and the leg portion 329 are shifted.

Each of the housing enlarged portions 327 is disposed on the back side of the impeller 20 in the rotation direction so as to be shifted by an angle β which is smaller than half of the predetermined angle α with respect to any one of the plurality of the leg portions 329. That is, in α and β, the following relational expression (1) satisfies. In the embodiment, since α=120°, β is smaller than 60°. It is preferable that each of the housing enlarged portions 327 is disposed as close as possible to the back side of the impeller 20 in the rotation direction with respect to each of the leg portions 329. With such a configuration, it is possible to suppress that the airflow S generated by the rotation of the impeller 20 is disturbed by the leg portions 329 and it is possible to increase an air volume of the blower 100.

β<α/2 (1)

Moreover, the housing opening portion 325 and the housing groove 326 are disposed on the back side of the impeller 20 in the rotation direction from the housing enlarged portion 327, between two leg portions 329 in the circumferential direction, which are adjacent to each other in the circumferential direction.

Next, an embodiment of the cleaner 200 to which the blower 100 of the embodiment is applied will be described. FIG. 11 is a perspective view of a cleaner 200 according to an exemplary embodiment of the disclosure. As illustrated in FIG. 11, the cleaner 200 has the blower 100. The cleaner 200 is a so-called stick type electric cleaner. Moreover, the cleaner including the blower 100 may be another type electric cleaner such as a so-called robot type, canister type, or handy type.

The cleaner 200 has a casing 201 in which an intake portion 202 and an exhaust portion 203 are respectively provided on a lower surface and an upper surface. The cleaner 200 has a rechargeable battery (not illustrated) and is operated by electric power supplied from the battery. However, the cleaner 200 may have a power supply cord and operate with electric power supplied via the power supply cord connected to a power supply outlet provided on a wall surface of a living room.

An air passage (not illustrated) for connecting the intake portion 202 and the exhaust portion 203 is formed in the casing 201. A dust collecting portion (not illustrated), a filter (not illustrated), and the blower 100 are disposed in order from the intake portion 202 (upstream) to the exhaust portion 203 (downstream) in the air passage. Trash such as dust contained in the air circulating through the air passage is captured by the filter and is collected in the dust collecting portion formed in a container shape. The dust collecting portion and the filter are configured to be attachable and detachable to and from the casing 201.

A grip portion 204 and an operation portion 205 are provided on an upper portion of the casing 201. A user can grasp the grip portion 204 and move the cleaner 200. The operation portion 205 has a plurality of buttons 205a. The user performs operation setting of the cleaner 200 with the operation of the buttons 205a. For example, a driving start, a driving stop, and a change in a rotational speed of the blower 100, and the like are instructed by operations of the buttons 205a. A rod-like suction pipe 206 is connected to the intake portion 202. A suction nozzle 207 is detachably attached to the suction pipe 206 at an upstream end of the suction pipe 206. Moreover, the upstream end of the suction pipe 206 is a lower end of the suction pipe 206 in FIG. 11.

According to the cleaner 200 of the embodiment, it is possible to efficiently cool the circuit board 50 included in the blower 100 by suppressing a decrease in the blowing efficiency. Therefore, it is possible to stabilize the operation of the circuit of the blower 100 and to stabilize the operation of the cleaner 200.

Various modifications can be made to the various technical features disclosed in the present specification without departing from the gist of the technical creation thereof. Also, a plurality of the embodiments and modification examples described in this specification may be implemented in combination in a possible range.

The present disclosure may be utilized, for example, in an electric machine having a blower such as a cleaner.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A blower comprising:
a motor including a shaft that is disposed along a vertically extending central axis;
an impeller fixed to the shaft and rotatable around the central axis;
a motor housing at least a portion of which is disposed on an outside of the motor in a radial direction;
a blower case at least a portion of which is disposed on the outside of the motor in the radial direction from an outer surface of the motor housing in the radial direction; and
a circuit board which is disposed below the motor housing and in which a plurality of circuit elements are disposed; wherein
a lower end portion of the motor housing includes a housing contraction portion in which a length of the motor housing in the radial direction decreases downwardly.

2. The blower according to claim 1, wherein the housing contraction portion is a curved portion which is projected downward and outward in the radial direction.

3. The blower according to claim 1, wherein a first circuit element having a highest temperature among the plurality of circuit elements is positioned on an inside in the radial direction from an outer end of the housing contraction portion in the radial direction.

4. The blower according to claim 3, wherein a region of at least a portion of the housing contraction portion in a circumferential direction overlaps the first circuit element in the radial direction.

5. The blower according to claim 1, wherein
the motor housing includes a housing recess portion which is recessed upwardly on an inside of the housing contraction portion in the radial direction; and
at least an upper portion of a second circuit element having a longest axial length among the plurality of circuit elements is accommodated in the housing recess portion.

6. The blower according to claim 1, wherein the motor housing includes:
the housing recess portion which is recessed upward on an inside of the housing contraction portion in the radial direction; and
a housing opening portion which penetrates through a portion between the housing contraction portion and the housing recess portion in the radial direction.

7. The blower according to claim 6, wherein
a plurality of the housing opening portions are provided in a circumferential direction; and
the plurality of housing opening portions are disposed at equal intervals in the circumferential direction.

8. The blower according to claim 1, wherein the motor housing includes a housing groove which is recessed on an inside in the radial direction in the housing contraction portion.

9. The blower according to claim 1, wherein the motor housing includes:
an upper housing; and
a lower housing disposed below the upper housing; and
the lower housing includes the housing contraction portion.

10. The blower according to claim 1, wherein
the motor housing includes a housing enlarged portion which is disposed between the housing contraction portion and another housing contraction portion in a circumferential direction, which are adjacent to each other in the circumferential direction, and protrudes to the outside of the motor in the radial direction;
a housing through-hole which penetrates in an axial direction is provided on an inside in the radial direction from an outer surface of the housing enlarged portion in the radial direction; and
a connecting portion which electrically connects the motor and the circuit board to each other is disposed in the housing through-hole.

11. The blower according to claim 10, wherein the housing through-hole extends forward in a rotation direction of the impeller inwardly in the radial direction.

12. The blower according to claim 11, wherein at least one of first circuit elements having a highest temperature among the plurality of circuit elements is disposed on a back side of the impeller in the rotation direction from an intermediate position in the circumferential direction between a front end of the impeller in the rotation direction in the housing through-hole, which is disposed on the back side of the impeller in the rotation direction, and a back end of the impeller in the rotation direction in the housing through-hole, which is disposed on the front side of the impeller in the rotation direction, between the housing through-holes in the circumferential direction, which are adjacent to each other in the circumferential direction.

13. The blower according to claim 10, wherein a plurality of the housing through-holes are disposed in the circumferential direction.

14. The blower according to claim 10, wherein the housing enlarged portion includes:
an enlarged portion outer wall portion which is disposed on the outside of the motor in the radial direction from the housing contraction portion; and
a pair of enlarged portion side wall portions which connect both end portions of the enlarged portion outer wall portion in the circumferential direction and the housing contraction portion; wherein
the enlarged portion side wall portion, which is disposed on a back side of the impeller in the rotation direction in the pair of enlarged portion side wall portions, includes a through-hole enlarged portion directed to the back side of the impeller in the rotation direction upwardly on a surface of the impeller on a front side in the rotation direction.

15. The blower according to claim 10, wherein
a plurality of the housing enlarged portions are disposed at equal intervals in the circumferential direction at predetermined angles;
the motor housing includes a plurality of leg portions protruding downward and connected to the circuit board;
the plurality of leg portions are disposed at equal intervals in the circumferential direction at the predetermined angles; and
each of the housing enlarged portions is disposed on a back side of the impeller in the rotation direction so as to be shifted by an angle which is smaller than half of the predetermined angles with respect to any one of the plurality of leg portions.

16. A cleaner comprising:
the blower according to claim 1.
